(19) United States
(12) Patent Application Publication
(10) Pub. No.: US 2014/0309446 A1
(43) Pub. Date: Oct. 16, 2014

(54) NOVEL AMINO-GROUP-CONTAINING SILOXANES, PROCESSES FOR THEIR PREPARATION AND USE

(71) Applicant: EVONIK DEGUSSA GMBH, Essen (DE)

(72) Inventors: Sadik Amajjahe, Dusseldorf (DE); Frauke Henning, Essen (DE); Wilfried Knott, Essen (DE); Christian Hartung, Essen (DE); Jutta Esselborn, Essen (DE); Frank Koenig, Gelsenkirchen (DE)

(73) Assignee: EVONIK DEGUSSA GMBH, Essen (DE)

(21) Appl. No.: 14/355,239

(22) PCT Filed: Oct. 5, 2012
(86) PCT No.: PCT/EP2012/069692

§ 371 Date: Apr. 30, 2014

(30) Foreign Application Priority Data
Oct. 31, 2011 (DE) 10 2011 085 492.4

(51) Int. Cl. C08G 77/392

(52) U.S. Cl. CPC C08G 77/392
USPC 556/418

(57) ABSTRACT

The invention relates to novel amino-group-containing siloxanes, to their preparation processes and to their use in care formulations for skin, hair and textiles.

### FIELD OF THE INVENTION

The invention relates to novel amino-group-containing siloxanes, their preparation processes and their use in care formulations for skin, hair and textiles.

### PRIOR ART

Siloxanes containing nitrogen functionality, in particular carrying amino groups, are commanding increasing importance in the field of textile finishing, but also for important leave-on applications in the cosmetics additive sector such as e.g. hair conditioning. Not least from aspects of sustainability, but also of biomimetics, the substance systems of interest here are those which revert to the natural pool of amino acids, proteins and derivatives thereof.

The chemical linking of the siloxane and amino acid or protein structures, which are characterized by a diametral difference in terms of substance, always constitutes a synthetic challenge. For example, it is a case of overcoming the difficulties arising due to the differing solubility behaviour of siloxanes and amino acids. There has therefore been no lack of manifold attempts, utilizing a very wide variety of different chemical linking concepts, to open up accesses to these interesting classes of substance.

Thus, e.g. U.S. Pat. No. 5,679,819 describes a copolymer comprising cysteine and/or its derivatives which are covalently bonded to a siloxane. Here, cysteine and/or its derivatives are reacted with epoxy- or anhydride-functionalized siloxanes.

EP 1149855 claims an alternative method for preparing amino-acid-functionalized siloxanes using an hydride-functionalized siloxanes.

WO 00/49090 discloses shear-stable aminosiloxane emulsions which are prepared by adding monocarboxylic acids to the aminosiloxanes with the formation of the corresponding salts.

JP 2004-182680 describes a cosmetic product which comprises a silicone polymer that has been modified by an amino acid derivative. This uses a complex 4-stage synthesis with some toxic intermediates in which, in the last step, an isocyanate-containing siloxane is coupled with a modified amino acid. However, the end products contain no free amino groups.

U.S. Pat. No. 5,516,869 discloses specific α,ω-amino-acid-modified siloxanes which are synthesized by the hydrosilylating linkage of alkenylpyrrolidones with α,ω-SiH-substituted siloxanes.

A further access method is the reaction, described in U.S. Pat. No. 5,412,074, of α,ω-epoxide-modified siloxanes with proteins, which produces products whose siloxane units are linked with one another via polypeptide bridges of undefined length.

U.S. Pat. No. 5,243,028 describes that siloxane units, proteins and alkylene oxide structures can be linked with one another. For this, firstly comb-like alkylene-oxide-substituted siloxanes are esterified with chloroacetic acid. In the subsequent step, these chloroacetic acid units are alkylated with free amino groups of proteins.

The methods of coupling amino acids or peptides onto siloxanes used in the prior art consist specifically of epoxide ring-opening reactions, esterifications and transesterifications, amidations, and substitution reactions. The disadvantages of the processes described therein lie sometimes in their multiple stages, in the use of often toxic and difficult-to-handle feed materials, in the requirement for high temperatures coupled with undesirably long reaction times and not least, as their consequence, in the secondary reactions leading here to discoloration and crosslinking, and low yields.

In contrast to the somewhat older modification reactions on siloxanes, the free-radically initiated reaction of thiols with olefins is also characterized by the attributes characteristic of click reactions: it produces quantitative yields, requires only small concentrations of standard commercial free-radical initiators, but proceeds with high reaction rates. It can either be carried out without dilution or in environmentally-friendly solvents and requires virtually no work-up to separate off undesired by-products and is insensitive to air and water.

The thiol-ene reaction is already described in the prior art for modifying silanes. For example, JP 2005307196 discloses the preparation of dendritic silane polymers by firstly reacting bis(dimethyldivinylsilyl)methylsilane in a hydrosilylation and functionalizing the reaction products in a thiol-ene reaction with mercapto alcohols or mercapto acids.

WO 2007090676 A1 describes the production of functionalized silica particles by functionalizing trimethoxyvinylsilane by means of thiol-ene reaction inter alia with N-acetylcysteine, followed by conversion to modified silica particles by hydrolysis and condensation reactions with tetraethoxysilane.

A further application of the thiol-ene reaction can be found in JP 2003026810 A, which describes the preparation of organooxy-terminated organopolysiloxanes for room-temperature-curing 1K systems. For this, γ-mercaptopropyltrimethoxysilane is reacted with α,ω-divinylpolysiloxanes by means of a free-radical initiator. The curing behaviour of the resulting siloxanes was described.

S. Abed and colleagues describe in Polymeric Materials Science and Engineering, 1997, 45-46, the modification of vinylsiloxanes with N-acetylcysteine and the aggregation of the resulting systems on the basis of hydrogen bridges.

However, the works relating to thiol-ene chemistry just described still do not offer a universal teaching relating to the simple and universal preparation of amino acid-derivatized siloxanes with free, i.e. unprotected, amino groups.

As is known to the person skilled in the art, silanes have a much higher reactivity than siloxanes. Organic substituents such as e.g. alkoxy groups give silanes a hydrophilic character, meaning that these are used inter alia as adhesion promoters between plastics and polar substrates. Siloxanes are hydrophobic, of higher viscosity and moreover have considerably poorer solubilities in those polar media which are usually suitable for dissolving amino acids and/or their derivatives. Against this background, it is also understandable why the prior art hitherto has no thiol-ene reactions for the modification of siloxanes with such amino acids or thiol-functional peptides in which the amino groups of the amino acids to be reacted in each case are unprotected. Since amino acids and peptides moreover form strong hydrogen bridge bonds with one another, their solubility is in most cases deficient in the nonaqueous systems that typically solvate siloxane.

Faced with this fundamental dilemma of conflicting solubility behaviour, the challenge and object of the present invention is to provide siloxanes with free amino groups.

### SUMMARY OF THE INVENTION

Surprisingly, it has been found that the amino-group-containing siloxanes described below can be prepared from amino acids and peptides and derivatives thereof using simple agents and have good application properties.

The invention further provides a process for producing the siloxanes according to the invention, formulations comprising these, and their use as conditioners.

An advantage of the present invention is the toxicological acceptability of the siloxanes according to the invention.

It is likewise possible to dispense with the use of individual components in excess for achieving satisfactory conversions.

Advantages of the organopolysiloxanes according to the invention and formulations comprising these are also the use for the first finishing of textiles (textile conditioning), as processing aids for the production and finishing of natural or synthetic fibres, in detergents and cleaners, in polishes and care compositions for treating hard surfaces, for coating and drying painted surfaces of automobiles, as corrosion inhibitors and for conditioning skin and hair.

It is a further advantage that the siloxanes according to the invention have an increased thermal as well as oxidative stability, resulting in less yellowing compared to conventional aminosiloxanes.

It is another advantage that in the process according to the invention it is possible to dispense with the use of individual components in excess for achieving satisfactory conversions.

### BRIEF DESCRIPTION OF THE DRAWINGS

FIG. 1 is a graph illustrating the reductions in friction value for various formulations examples.

### DETAILED DESCRIPTION OF THE INVENTION

The present invention provides siloxanes according to the general formula I

Mₐ₁M^{A}ₐ₂M^{B}ₐ₃M^{C}ₐ₄D_{b1}D^{A}_{b2}D^{B}_{b3}D^{C}_{b4}T_{c1}T^{A}_{c2}T^{B}_{c3}T^{C}_{c4}Q_{d1} (general formula I)

where

### M=[R¹₃SiO_{1/2}]

### M^{A}=[R²R¹₂SiO_{1/2}]

### M^{B}=[R²R¹₂SiO_{1/2]}

### M^{B}=[R³R¹₂SiO_{1/2}]

### M^{C}=[R⁴R¹₂SiO_{1/2}]

### D=[R¹₂SiO_{2/2}]

### D^{A}=[R²₁R¹₁SiO_{2/2}]

### D^{B}=[R³₁R¹₁SiO_{2/2}]

### D^{C}=[R⁴₁R¹₁SiO_{2/2}]

### T=[R¹SiO_{3/2}]

### T^{A}=[R²SiO_{3/2}]

### T^{B}=[R³SiO_{3/2}]

### T^{C}=[R⁴SiO_{3/2}]

### Q=[SiO_{4/2}],

where
R¹ independently of one another are identical or different linear or branched, saturated or unsaturated hydrocarbon radicals having 1 to 30 carbon atoms or else aromatic hydrocarbon radicals having 6 to 30 carbon atoms, preferably methyl or phenyl, in particular methyl,
R² independently of one another are identical or different radicals of the general formula II

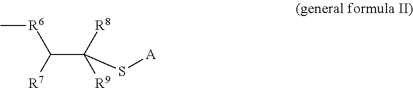

where A=organic radical having at least one primary amino group and at least one selected from carboxy group and ester group,
R⁶ is a direct bond, any desired divalent organic radical bonded to the siloxane, preferably selected from substituted, for example C₆-C₁₂-aryl-substituted, or unsubstituted C₁-C₃₀-alkylene, which can also be interrupted by heteroatoms, substituted or unsubstituted, cyclic C₃-C₃₀-alkylene, substituted or unsubstituted C₁-C₃₀-alkyleneoxy, substituted or unsubstituted C₆-C₃₀-arylene, substituted or unsubstituted C₆-C₃₀-aryleneoxy, substituted or unsubstituted C₁-C₃₀-alkenyl, esters, amides,
R⁷ is hydrogen, substituted, for example C₆-C₁₂-aryl-substituted, or unsubstituted C₁-C₃₀-alkyl, substituted or unsubstituted C₆-C₃₀-aryl, substituted or unsubstituted C₆-C₃₀-heteroaryl, substituted or unsubstituted C₁-C₃₀-alkyloxy, substituted or unsubstituted cyclic C₃-C₃₀-alkyl, substituted or unsubstituted C₁-C₃₀-alkenyl, preferably hydrogen or substituted or unsubstituted C₁-C₂₀-alkyl,
R⁸ is hydrogen, substituted, for example C₆-C₁₂-aryl-substituted, or unsubstituted C₁-C₃₀-alkyl, substituted or unsubstituted C₆-C₃₀-aryl, substituted or unsubstituted C₆-C₃₀-heteroaryl, substituted or unsubstituted C₁-C₃₀-alkyloxy, substituted or unsubstituted cyclic C₃-C₃₀-alkyl, substituted or unsubstituted C₁-C₃₀-alkenyl, preferably hydrogen or substituted or unsubstituted C₁-C₂₀-alkyl,
R⁹ is hydrogen, substituted, for example C₆-C₁₂-aryl-substituted, or unsubstituted C₁-C₃₀-alkyl, substituted or unsubstituted C₆-C₃₀-aryl, substituted or unsubstituted C₆-C₃₀-heteroaryl, substituted or unsubstituted C₁-C₃₀-alkyloxy, substituted or unsubstituted cyclic C₃-C₃₀-alkyl, substituted or unsubstituted C₁-C₃₀-alkenyl, preferably hydrogen or substituted or unsubstituted C₁-C₂₀-alkyl,
R³ independently of one another are identical or different linear or branched, saturated or olefinically unsaturated hydrocarbon radicals having 8 to 30 carbon atoms, for example decyl, dodecyl, tetradecyl, hexadecyl, octadecyl, in particular hexadecyl and octadecyl,
R⁴ independently of one another are identical or different linear or branched hydrocarbon radicals which carry nitrogen- and/or oxygen-functional groups, such as, for example, aminoalkyl groups or polyhydroxy-functional aliphatic radicals,
a1=0-200, preferably 1-60, in particular 0,
a2=0-30, preferably 1-20, in particular 2-10,
a3=0-30, preferably 1-20, in particular 0,
a4=0-30, preferably 1-20, in particular 0,
b1=10 to 5000, preferably 10 to 1000, in particular 10-500,
b2=0 to 100, preferably 1 to 30, in particular 1-10,
b3=0 to 100, preferably 0 to 30, in particular 0,
b4=0 to 100, preferably 0 to 30, in particular 0,
c1=0 to 30, preferably 1 to 30,
c2=0 to 30, preferably 0 to 5, in particular 0,
c3=0 to 30, preferably 0 to 5, in particular 0,
c4=0 to 30, preferably 0 to 5, in particular 0,
d1=0 to 30, preferably 1 to 5,
with the proviso that at least one of the indices a2, b2 or c2 is ≠0 and that at least one of the indices a1 to a4 is ≠0.

In connection with the present invention, the term “primary amino group” is to be understood as meaning an —NH₂ group, which may optionally be present in protonated form depending on the pH of the medium in question.

In connection with the present invention, the term “carboxy group” is to be understood as meaning a —COOH group which can optionally be present in deprotonated form depending on the pH of the medium in question.

If radicals R⁶ are interrupted by nitrogen heteroatoms, then these can also be quaternized, and carry sulphates, chlorides and carboxylates, in particular citrates, lactates, stearates and acetates as counterions.

Siloxanes preferred according to the invention are characterized by a parameter choice selected from the group:

a1=0, a2=2, a3=0, a4=0, b1=5-350, b2-0, b3-0, b4-0, c1-0, c2-0, c3-0, c4=0 and d1=0,
a1=3-12, a2=0, a3=0, a4=0, b1=15-350, b2=0, b3=0, b4=0, c1=0, c2=1-10, c3=0, c4=0 and d1=0,
a1=2, a2=0, a3=0, a4=0, b1=10-350, b2=1-30, b3=0, b4=0, c1=0, c2=0, c3=0, c4=0 and d1=0,
a1=0, a2=2, a3=0, a4=0, b1=10-350, b2=1-30, b3=0, b4=0, c1=0, c2=0, c3=0, c4=0 and d1=0,
a1=0, a2=3-12, a3=0, a4=0, b1=15-350, b2=0, b3=0, b4=0, c1=1-10, c2=0, c3=0, c4=0 and d1=0,
a1=0, a2=4-22, a3=0, a4=0, b1=20-350, b2=0, b3=0, b4=0, c1=0, c2=0, c3=0, c4=0 and d1=1-10,
a1=2-11, a2=2-11, a3=0, a4=0, b1=20-350, b2=0, b3=0, b4=0, c1=0, c2=0, c3=0, c4=0 and d1=1-10,
a1=2-11, a2=2-11, a3=0, a4=0, b1=20-350, b2=1-10, b3=0, b4=0, c1=0, c2=0, c3=0, c4=0 and d1=1-10,
a1=0, a2=3-12, a3=0, a4=0, b1=15-350, b2=1-10, b3=0, b4=0, c1=1-10, c2=0, c3=0, c4=0 and d1=0,
a1=3-12, a2=0, a3=0, a4=0, b1=15-350, b2=1-10, b3=0, b4=0, c1=0,
c2=1-10, c3=0, c4=0 and d1=0 and
a1=0, a2=5-17, a3=0, a4=0, b1=30-350, b2=0, b3=0, b4=0, c1=1-5, c2=0, c3=0, c4=0 and d1=1-5.

Siloxanes preferred according to the invention have radicals R² where

R⁶ independently of one another are identical or different radicals of the general formula III

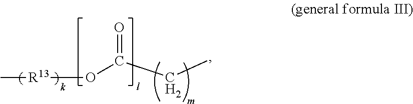

where
k=0 or 1, in particular 0,
l=0 or 1, in particular 0,
m=0-30, preferably 0-8, in particular 0,
R¹³ is hydrocarbon radicals, for example hexenol or polyoxyalkenol radicals, optionally substituted with —O—, —NH— or hydroxy groups,
R⁷ is hydrogen or substituted or unsubstituted C₁-C₂₀-alkyl, preferably hydrogen
R⁹ is hydrogen or substituted or unsubstituted C₁-C₂₀-alkyl, preferably hydrogen
R⁹ is hydrogen or substituted or unsubstituted C₁-C₂₀-alkyl, preferably hydrogen.

Siloxanes preferred according to the invention have radicals R² selected from IIa to IIk

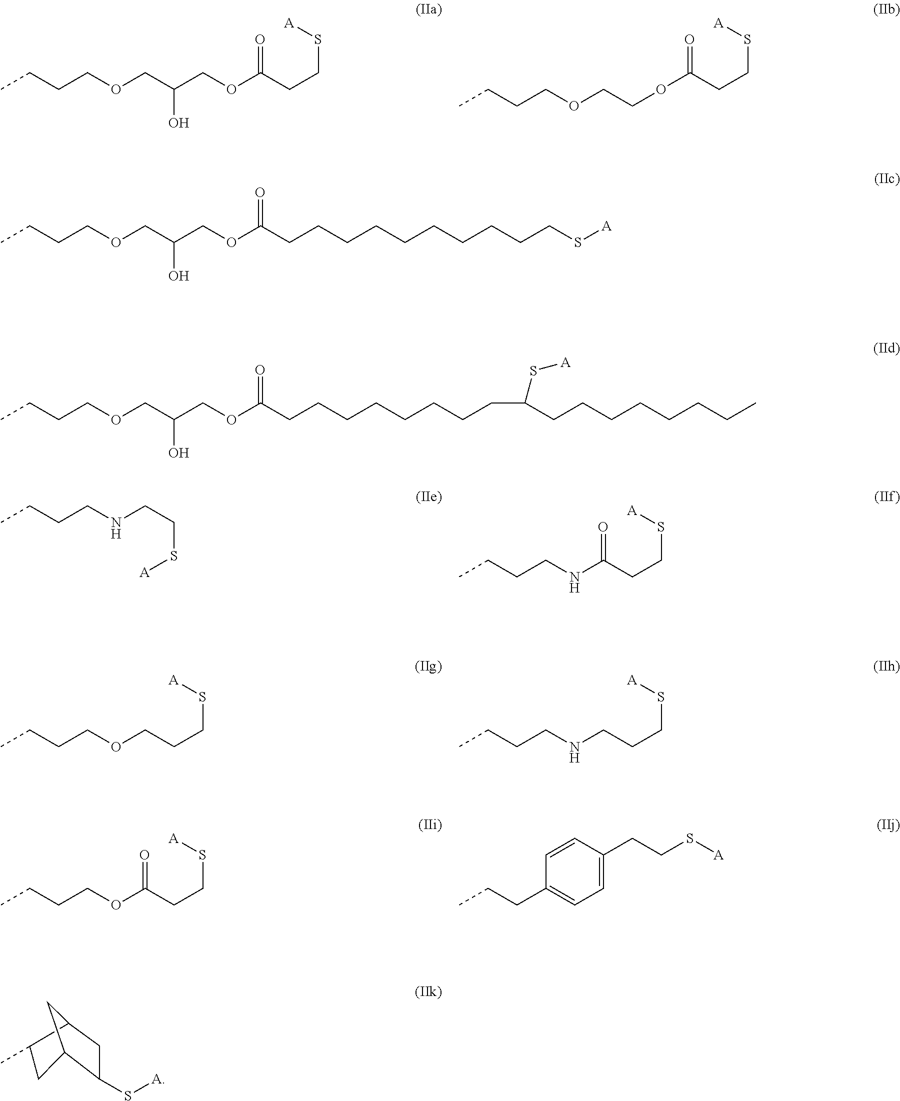

The sulphur atom in the group —S-A of the general formula II is preferably derived from the thiol group of an optionally derivatized cysteine.

According to the invention, preference is given to a cysteine derivatization via peptidic linkage with further amino acids, in particular alpha-amino acids, on the N- and/or C-terminus. These amino acids bonded to cysteine can for their part in turn be linked via peptidic bonds with further amino acids, in particular alpha-amino acids.

The above gives rise to a preferred structure of the group —S-A of the general formula II which is derived from an oligo- or polypeptide containing at least one cysteine radical.

In connection with the present invention, the term “oligopeptide” is to be understood as meaning peptides which are composed of up to 10 amino acids, whereas the term “polypeptide” is to be understood in connection with the present invention as meaning peptides which are composed of 11 or more amino acids.

In this connection, preferred amino acids forming the cysteine-radical-containing peptide are selected from L-alpha-amino acids, in particular from the 22 proteinogenic amino acids, which can be optionally glycosylated, selected from glycine, alanine, valine, leucine, isoleucine, proline, methionine, phenylalanine, tyrosine, tryptophan, serine, threonine, asparagine, glutamine, cysteine, lysine, arginine, histidine, aspartate, selenocysteine, pyrrolysine and glutamate.

The aforementioned peptide is preferably composed of 2 to 400, preferably 2 to 50, in particular 2 to 10, amino acids.

The C-terminus of the aforementioned peptide can be esterified with an alcohol radical R¹⁰.

It is preferred according to the invention that the group —S-A of the general formula II corresponds to the general formula IV

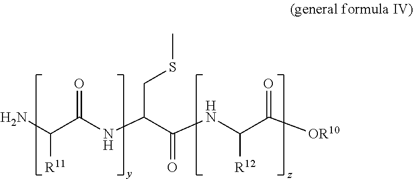

where
y=0 to 400, preferably 0 to 50, in particular 0 to 1,
z=0 to 400, preferably 0 to 50, in particular 0 to 1,
R¹⁰=H, fatty alcohol radicals, alkyl radicals, preferably C1 to C32, in particular H
R¹¹=independently of one another identical or different organic radicals or H
R¹²=independently of one another identical or different organic radicals or H

In connection with the present invention, the term “fatty alcohol” is to be understood as meaning primary alcohols with an unbranched, optionally mono- or polyunsaturated hydrocarbon radical having 8 to 22 carbon atoms.

Preferred radicals R¹¹ and R¹² are selected from the group comprising

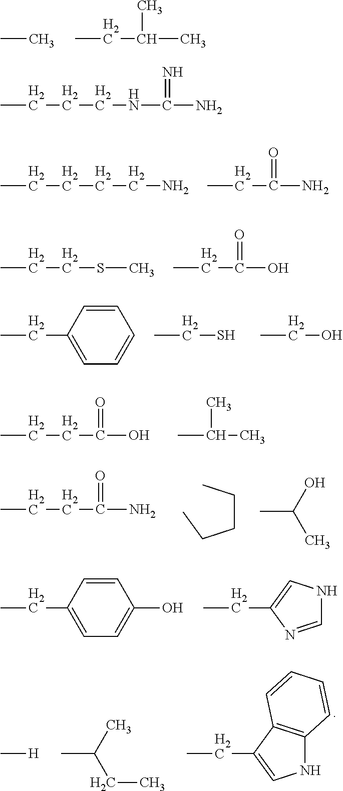

The amino acids forming the peptide and depicted by the general formula IV preferably have an L-configuration.

In a very preferred siloxane according to the invention, the group —S-A of the general formula II is selected from those of the general formula IV in which y=z=0 and R¹²=H.

In an alternative and equally preferred embodiment, the group —S-A in the general formula II corresponds to the structure

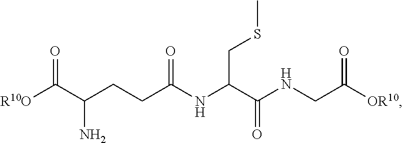

where the two groups R¹⁰ are identical or different as mentioned above, but in particular H.

For this structure, it is particularly preferred that it is derived from naturally occurring glutathione and corresponds to this in its stereochemistry.

Polysiloxanes according to the invention preferably have no N-acylation in the radical A since this limits the use in hair and textile conditioning.

Polysiloxanes according to the invention preferably have radicals of the general formula IIIa to IIIh as R⁴

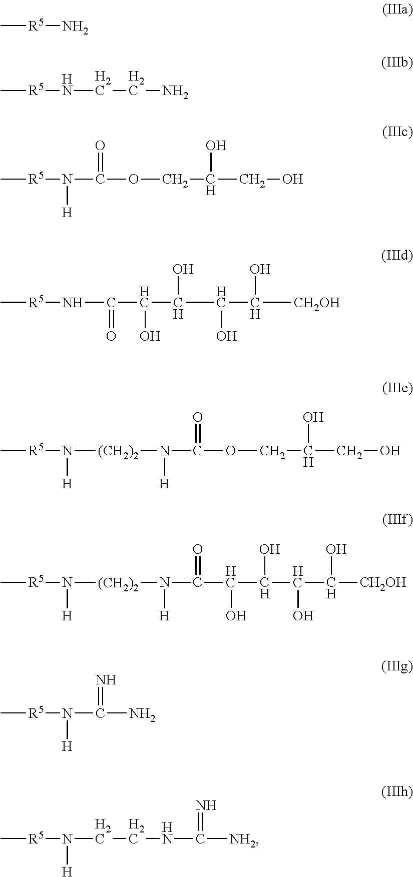

where
R⁵ independently of one another are identical or different linear or branched, saturated or unsaturated, divalent hydrocarbon radicals, preferably —(CH₂)₃ radicals.

The different monomer units of the siloxane chains given in the formulae can be arranged blockwise with one another with any desired number of blocks and be subject to an arbitrary sequence or a statistical distribution. The indices used in the formulae are to be regarded as statistical averages.

A polysiloxane according to the invention can contain different groups —S-A of the general formula II.

The present invention further provides a process for preparing siloxanes containing amino groups by thiol-ene reaction.

In a preferred embodiment of the process according to the invention for preparing the amino-group-containing siloxanes according to the invention, the starting materials are reacted in the presence of one or more free-radical initiators in one process step.

The process according to the invention for preparing amino-group-containing siloxanes is characterized in that a mixture comprising

a) at least one siloxane with at least one olefinically unsaturated radical,
b) at least one organic compound containing at least one thiol group, at least one primary amino group and at least one selected from carboxy group and ester group, optionally
c) at least one solvent and optionally
d) at least one free-radical initiator
is reacted.

As component a), it is possible to use those siloxanes with olefinically unsaturated radicals in which the olefinically unsaturated radicals are arranged in the siloxane in an entirely terminal manner, entirely lateral manner or in a mixed terminal and lateral manner. It is also possible to use cyclic siloxanes with olefinically unsaturated radicals. In particular, use is made of siloxanes with olefinically unsaturated radicals of the general formula Ia

Mₐ₁M^{A}ₐ₂M^{B}ₐ₃M^{C}ₐ₄D_{b1}D^{A}_{b2}D^{B}_{b3}D^{C}_{b4}T^{A}_{c2}T^{B}_{c3}T^{C}_{c4}Q_{d1} (general formula Ia)

where

### M=[R¹₃SiO_{1/2}]

### M^{A}=[R^{2a}R¹₂SiO_{1/2}]

### M^{B}=[R³R¹₂SiO_{1/2}]

### M^{C}=[R⁴R¹₂SiO_{1/2}]

### D=[R¹₂SiO_{2/2}]

### D^{A}=[R^{2a}₁R¹₁SiO_{2/2}]

### D^{B}=[R³₁R¹₁SiO_{2/2}]

### D^{C}=[R⁴₁R¹₁SiO_{2/2}]

### T=[R¹SiO_{3/2}]

### T^{A}=[R^{2a}SiO_{3/2}]

### T^{B}=[R³SiO_{3/2}]

### T^{C}=[R⁴SiO_{3/2}]

### Q=[SiO_{4/2}],

where R¹, R³, R⁴ and all of the indices are as described above for the general formula I and
R^{2a} independently of one another are identical or different olefinically unsaturated radicals,
with the proviso that at least one of the indices a2, b2 or c2 is ≠0 and that at least one of the indices a1 to a4 is ≠0.

Siloxanes used in the process that are preferred according to the invention are characterized by a parameter choice selected from the group:

a1=0, a2=2, a3=0, a4=0, b1=5-350, b2-0, b3-0, b4-0, c1-0, c2-0, c3-0, c4=0 and d1=0,
a1=3-12, a2=0, a3=0, a4=0, b1=15-350, b2=0, b3=0, b4=0, c1=0, c2=1-10, c3=0, c4=0 and d1=0,
a1=2, a2=0, a3=0, a4=0, b1=10-350, b2=1-30, b3=0, b4=0, c1=0, c2=0, c3=0, c4=0 and d1=0,
a1=0, a2=2, a3=0, a4=0, b1=10-350, b2=1-30, b3=0, b4=0, c1=0, c2=0, c3=0, c4=0 and d1=0,
a1=0, a2=3-12, a3=0, a4=0, b1=15-350, b2=0, b3=0, b4=0, c1=1-10, c2=0, c3=0, c4=0 and d1=0,
a1=0, a2=4-22, a3=0, a4=0, b1=20-350, b2=0, b3=0, b4=0, c1=0, c2=0, c3=0, c4=0 and d1=1-10,
a1=2-11, a2=2-11, a3=0, a4=0, b1=20-350, b2-0, b3-0, b4-0, c1=0, c2=0, c3=0, c4=0 and d1=1-10,
a1=2-11, a2=2-11, a3=0, a4=0, b1=20-350, b2=1-10, b3=0, b4=0, c1=0, c2=0, c3=0, c4=0 and d1=1-10,
a1=0, a2=3-12, a3=0, a4=0, b1=15-350, b2=1-10, b3=0, b4=0, c1=1-10, c2=0, c3=0, c4=0 and d1=0,
a1=3-12, a2=0, a3=0, a4=0, b1=15-350, b2=1-10, b3=0, b4=0, c1=0, c2=1-10, c3=0, c4=0 and d1=0 and
a1=0, a2=5-17, a3=0, a4=0, b1=30-350, b2=0, b3=0, b4=0, c1=1-5, c2=0, c3=0, c4=0 and d1=1-5.

According to the invention, it is preferred that siloxanes are used in the process in which the olefinically unsaturated radicals correspond to the general formula V

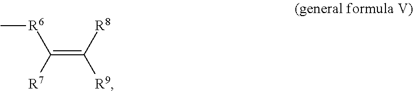

where R⁶ to R⁹ are as described above in the general formula II.

In the process according to the invention, siloxanes with preferred radicals R⁶ to R⁹ as described above for the preferred siloxanes according to the invention in the general formula II are used in particular.

The olefinically unsaturated radicals of the general formula V correspond in particular to one selected from the formulae VIa to VIk.

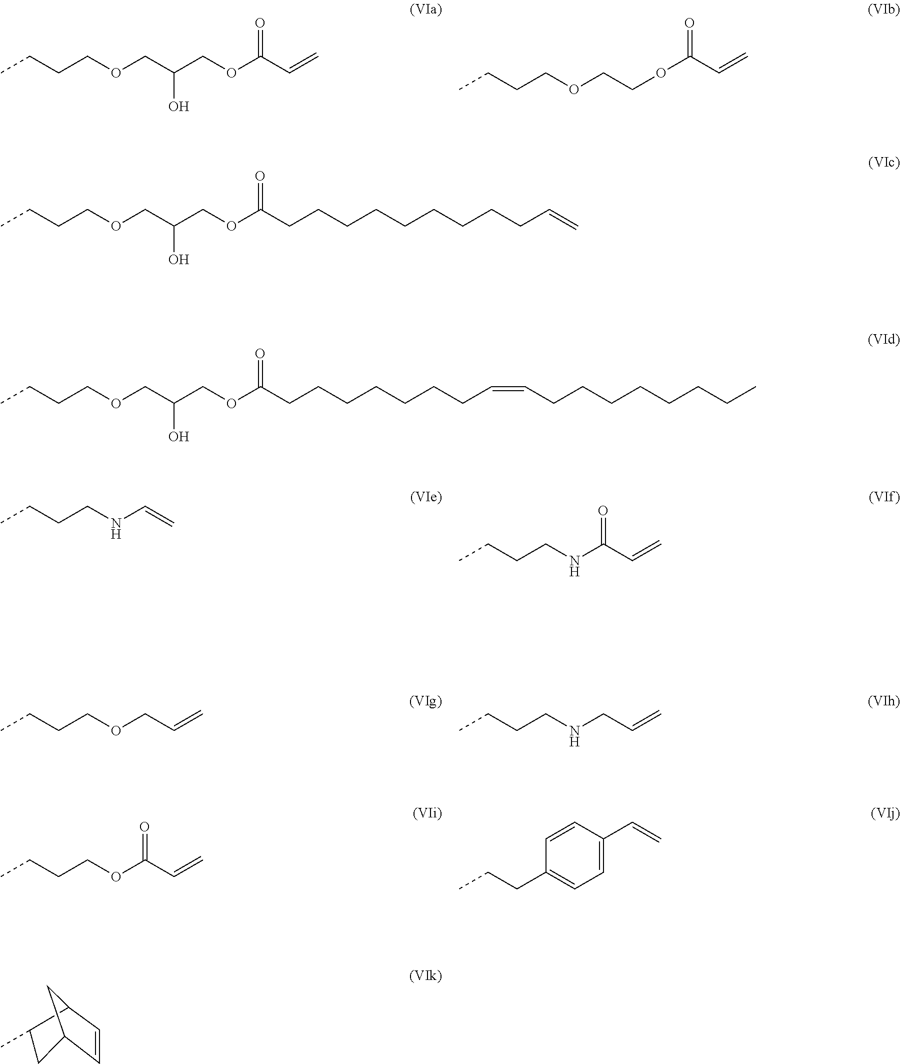

As component b), preference is given to using those selected from oligo- or polypeptides containing at least one cysteine, which can be glycosylated or esterified on the C-terminus with an alcohol radical R¹⁰, as specified above in connection with the general formula IV.

In this connection, preferred amino acids forming the cysteine-containing peptide are selected from L-alpha-amino acids, in particular from the 22 proteinogenic amino acids, which can optionally be glycosylated, selected from glycine, alanine, valine, leucine, isoleucine, proline, methionine, phenylalanine, tyrosine, tryptophan, serine, threonine, asparagine, glutamine, cysteine, lysine, arginine, histidine, aspartate, selenocysteine, pyrrolysine and glutamate.

The aforementioned peptide is preferably composed of 2 to 400, preferably 2 to 100, in particular 2 to 10, amino acids.

As component b), it is possible to use in particular plant proteins, their hydrolysates and their derivatives such as e.g. wheat protein, corn protein, soya protein, almond protein etc. and animal proteins, their hydrolysates and derivatives such as e.g. milk protein, beef collagen, fish collagen and silk protein, with in particular hydrolysates being preferably used since these can be adjusted to a desired preferred size of the peptide. In an alternative and equally preferred embodiment, cysteine or glutathione is used as component b).

Components b) preferably used according to the invention have no N-acylation since this limits the application of the resulting amino-group-containing siloxanes in hair and textile conditioning.

Particularly preferably used component b) is described by the general formula IVa

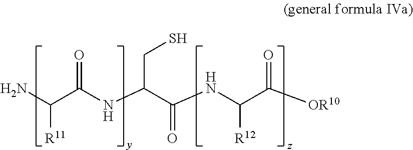

where y, z, R¹⁰, R¹¹ and R¹² are as specified above in connection with the general formula IV.

Radicals R¹¹ and R¹² preferred in this connection are selected from the group comprising

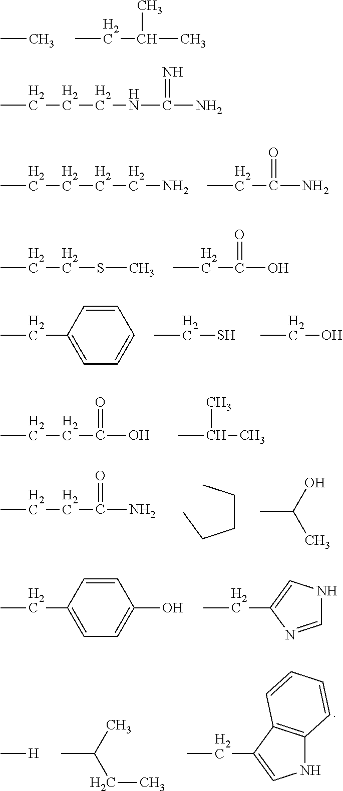

The amino acids forming the component b) preferably have an L-configuration.

In an especially preferred process according to the invention, the component b) is selected from those of the general formula IVa in which y=z=0 and R¹²=H.

In an alternative and equally preferred embodiment, the component b) corresponds to the structure

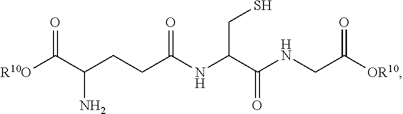

where the two groups R¹⁰ are identical or different as mentioned above, but in particular H.

For this structure it is particularly preferred that it is derived from naturally occurring glutathione and corresponds to this in its stereochemistry.

Solvents used as component c) can be, for example, water, acetone, acetonitrile, tert-butanol, chloroform, dichloromethane, acetic acid, bis(2-methoxyethyl)ether, dimethylacetamides, ethanol, ethylene glycol, methanol, isopropanol, diethyl ether, pyridine, dimethyl sulphoxide, dimethyl formamide, polyethers and mixtures thereof. Particular preference is given to using protic solvents which can at least partially contain water; preferably, the pH of the solvent here at 25° C. is in a range from 1 to 14, preferably 3 to 9, in particular 5 to 7.

In an alternative but no less preferred embodiment, it is possible to work in at least two solvents which form a multiphase system.

Those systems composed of at least two components c) include, for example, at least one component selected from water, chloroform, diethyl ether, dichloromethane, toluene and xylene.

According to the invention, such multiphase systems preferably comprise at least one phase transfer catalyst; examples of suitable phase transfer catalysts are the substance groups comprising tetraalkylammonium salts, benzyltrialkylammonium salts, tetraalkylphosphonium salts, benzyltrialkylphosphonium salts and mixtures thereof. In the process according to the invention, the ammonium salts are preferred over the phosphonium salts, and the tetra-n-butylammonium, tri-n-butylmethylammonium and benzyltriethylammonium salts are particularly suitable, especially with the anions chloride, bromide or hydrogen sulphate.

Free-radical initiators used as component d) can either be azo, peroxide, percarbonate and/or photoinitiators, such as e.g. 2,2′-azobis[2-(2-imidazolin-2-yl)propane]dihydrochloride, 2,2′-azobis(2-methylpropionamidine)dihydrochloride, 2,2′-azobis[2-(2-imidazolin-2-yl)propane], 2,2′-azobis[2-methyl-N-(2-hydroxyethyl)propionamide], 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), dicumyl peroxide, di-tert-butyl peroxide, dibenzoyl peroxide, tert-butyl hydroperoxide, diisopropyl peroxydicarbonate, tert-butyl perbenzoate, as well as photoinitiators such as e.g. 2,2-dimethoxy-2-phenylacetophenone, 4,4′-dihydroxybenzophenone, camphorquinone, benzophenone, 2-isobutoxy-2-phenylacetophenone, anthraquinone, 4′-hydroxyacetophenone etc.

The free-radical initiator is used in an amount of from 0.1 mol % to 20 mol %, based on the siloxane with olefinically unsaturated radicals, but preferably in an amount of from 0.1 mol % to 10 mol %, particularly preferably in an amount of from 1 mol % to 5 mol %. The free-radical initiator can either be weighed in at the start of the reaction or be metered in portions over a substrate-dependent time interval.

The process according to the invention can be carried out at a temperature ranging from 20 to 200° C., preferably from 20 to 120° C., particularly preferably from 40 to 100° C.

If the components b) used are thermolabile compounds, then in one embodiment of the process according to the invention, an implementation of the process according to the invention at low temperatures is preferred. This can be achieved in particular by using photoinitiators as component d), particularly those selected from 2,2-dimethoxy-2-phenylacetophenone, 4,4′-dihydroxybenzophenone, camphorquinone, benzophenone, 2-isobutoxy-2-phenylacetophenone, anthraquinone and 4′-hydroxyacetophenone, and allowing the reactions to proceed with UV induction, in which case the process is carried out in a temperature range from 20 to 100° C., preferably from 20 to 80° C., particularly preferably from 20 to 40° C.

The process according to the invention can be carried out in a pressure range from 0 to 20 bar, preferably 0 to 2 bar, particularly preferably at 0.9 to 1.1 bar.

The process according to the invention can be carried out either under inertization with noble gases such as e.g. argon, or else under nitrogen or under customary atmosphere. Particular preference is given to carrying it out under inert gas, with nitrogen being particularly preferred.

The reaction mixture can be obtained by means of any desired mixing of the component.

The preparation of the amino-acid-containing siloxanes can be carried out either as a one-pot process (batch process) or else via the metered addition of the raw materials. In the case of the latter, preference is given to initially introducing the thiol-containing component b) and metering in the olefinically unsaturated component a) and the free-radical initiator d) over a period of 0.5-2 hours.

Particularly preferably, firstly the starting materials and optionally solvents are mixed and then the free-radical initiator is added in one portion.

According to the invention, preference is given to a process time of less than four hours.

The process according to the invention is preferably carried out in the batch process.

A further subject matter is a siloxane obtainable by the process according to the invention.

The present invention further provides the use of the siloxanes according to the invention and/or the siloxanes obtainable by the process according to the invention for producing formulations, in particular cosmetic or pharmaceutical formulations and care and cleaning formulations for use in the domestic and industrial sector. In this connection, preferred cosmetic or pharmaceutical formulations are in particular skin and hair treatment formulations, in particular hair conditioning formulations. Preferred care and cleaning formulations for use in the domestic and industrial sector are in this connection textile care compositions, such as, for example, fabric softeners, and care compositions for hard surfaces, in particular for vehicles, watercraft, aeroplanes, window panes and sills, shower dividers, floorings such as carpets, tiles, laminates, parquet, cork flooring, marble, stone and fine stoneware floors, household ceramics such as toilets, washing basins, bidets, shower trays, bathtubs, door handles, fittings, domestic appliances such as washing machines, tumble driers, dishwashers, sinks made from ceramic or stainless steel, furniture such as tables, chairs, benches, worktops, windows, pots and pans, crockery and cutlery, tools such as surgical instruments, vacuum cleaners, engines, pipelines, tanks and devices for transportation, processing and storage in food processing, such as, for example, rinse aids.

Consequently, formulations, in particular cosmetic or pharmaceutical formulations and care and cleaning formulations for use in the domestic and industrial sector, comprising siloxanes according to the invention and/or siloxanes obtainable by the process according to the invention, in particular in an amount of 0.1 to 7% by weight, preferably 0.5 to 4% by weight, particularly preferably 1 to 3% by weight, based on the total formulation, in particular aqueous formulations which preferably have a pH of from 3.5 to 5.5, are further provided by the present invention.

Preferred formulations according to the invention contain no further siloxanes.

In this connection, the term “aqueous” is to be understood as meaning a water content of greater than 50% by weight, preferably greater than 75% by weight, based on the total formulation.

Preferred formulations according to the invention are cosmetic hair and skincare formulations, in particular hair care formulations. According to the invention, particularly preferred formulations are therefore hair shampoos, hair rinses, hair setting compositions, blow-drying setting compositions, hair care emulsions, hair treatments, aerosol mousses, hair colorants and blow-drying lotions.

The formulations according to the invention can comprise e.g. at least one additional component selected from the group of
emollients,
coemulsifiers,
thickeners/viscosity regulators/stabilizers,
antioxidants,
hydrotropes (or polyols),
solids and fillers,
pearlescent additives,
deodorant and antiperspirant active ingredients,
insect repellents,
self-tanning agents,
preservatives,
conditioners,
perfumes,
dyes,
cosmetic active ingredients,
care additives,
superfatting agents,
solvents.

Substances which can be used as exemplary representatives of the individual groups are known to the person skilled in the art and can be found for example in the German application DE 102008001788.4. This patent application is hereby incorporated by reference and thus forms part of the disclosure.

As regards further optional components and the amounts of these components used, reference is expressly made to the relevant handbooks known to the person skilled in the art, e.g. K. Schrader, “Grundlagen and Rezepturen der Kosmetika [Fundamentals and Formulations of Cosmetics]”, 2nd edition, page 329 to 341, Huthig Buch Verlag Heidelberg.

The amounts of the particular additives are governed by the intended use.

Typical guide formulations for the particular applications form the known prior art and are contained for example in the brochures from the manufacturers of the particular basic materials and active ingredients. These existing formulations can generally be adopted unchanged. If necessary, however, the desired modifications can be undertaken without complication by means of simple experiments for the purposes of adaptation and optimization.

The present invention further provides the use of the siloxanes and/or the siloxanes obtainable by the process according to the invention and/or at least one formulation according to the invention as care composition, in particular as skincare and hair care composition, and/or for conditioning hair, and/or as fabric softener.

The term “care composition” here is understood as meaning a substance which achieves the aim of returning an article to its original form, of reducing or avoiding the effects of external influences (e.g. time, light, temperature, pressure, soiling, chemical reaction with other reactive compounds that come into contact with the article) such as, for example, ageing, soiling, material fatigue, bleaching, or even of improving desired positive properties of the article. For the last point, mention may be made for example of improved hair shine or a greater elasticity of the article in question.

The present invention is described by way of example in the examples listed below without there being any intention of limiting the invention, the scope of application of which arises from the entire description and the claims, to the embodiments specified in the examples.

The following figures form part of the examples:

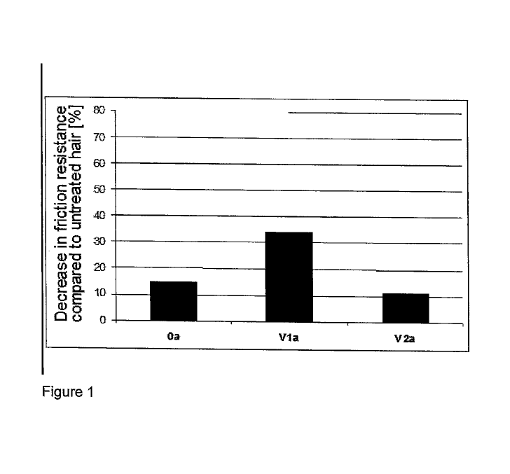

FIG. 1: Reductions in friction value

### EXAMPLES

### Preparation of the Amino-Acid- and Peptide-Modified Siloxanes According to the Invention

The recording and interpretation of the NMR spectra is known to the person skilled in the art. Reference may be made here to the book “NMR Spectra of Polymers and Polymer Additives” by A. Brandolini and D. Hills, published in 2000 by Verlag Marcel Dekker Inc.

### Synthesis Example S1

### According to the Invention

### M^{A}₂D₂₈

100 g of an α,ω-divinylsiloxane with a chain length of 30 monomer units, 17 g of cysteine ethyl ester hydrochloride (98% strength purity, obtainable from Sigma Aldrich), 118 g of isopropanol and 1.46 g of azobisisobutyronitrile (98% strength purity obtainable from Sigma Aldrich) were combined in a three-neck flask equipped with a KPG stirrer, an internal thermometer and a reflux condenser, and stirred for 5 hours at 65° C. The isopropanol was then distilled off at 90° C. and while applying an oil pump vacuum (at 1 mbar). The mixture was rinsed out several times using water/NaCl/diethyl ether. Finally, the separated-off organic phase was dried over sodium sulphate and the diethyl ether was distilled off. This gave a slightly cloudy, yellowish, viscous liquid. The ²⁹Si-NMR spectrum revealed a complete conversion of the vinyl groups.

### Synthesis Example S2

### According to the Invention

### M^{A}₂D₇₈

190 g of an α,ω-divinylsiloxane (N=80), 14.2 g of L-cysteine ethyl ester hydrochloride (98% obtainable from Sigma Aldrich), 204 g of isopropanol and 1.2 g of azobisisobutyronitrile (98% strength purity obtainable from Sigma Aldrich) were combined in a three-neck flask equipped with a KPG stirrer, an internal thermometer and a reflux condenser, and stirred for 6 hours at 65° C. The isopropanol was then distilled off at 90° C. and while applying an oil pump vacuum (at 1 mbar). The mixture was rinsed out several times using water/NaCl/diethyl ether. Finally, the separated-off ether phase was dried over sodium sulphate and the diethyl ether was distilled off. This gave a slightly cloudy, yellowish, viscous liquid. The ²⁹Si-NMR spectrum revealed a complete conversion of the vinyl groups.

### Synthesis Example S3

### According to the Invention

### M₂D^{A}₄D₄₁

50 g of a polyvinylsiloxane with a vinyl equivalent of 1000 g/mol, 9.5 g of L-cysteine ethyl ester hydrochloride (98% obtainable from Sigma Aldrich), 71.4 g of isopropanol and 1.9 g of azobisisobutyronitrile (98% strength purity obtainable from Sigma Aldrich) were combined in a three-neck flask equipped with a KPG stirrer, an internal thermometer and a reflux condenser, and stirred for 6 hours at 70° C. The isopropanol was then distilled off at 90° C. and while applying an auxiliary vacuum (at 1 mbar). The mixture was rinsed out several times using water/NaCl/diethyl ether. Finally, the separated-off organic phase was dried over sodium sulphate and the diethyl ether was distilled off. This gave a slightly cloudy, viscous liquid. Complete conversion of the vinyl groups was evident from the ²⁹Si-NMR spectrum.

### Comparative Example V1

### Not According to the Invention

### M⁴₂D₂₈

100 g of an α,ω-divinylsiloxane with a chain length of 30 monomer units, 12.35 g of N-acetylcysteine (99% strength purity, obtainable from Sigma Aldrich), 112 g of isopropanol and 1.45 g of azobisisobutyronitrile (98% strength purity obtainable from Sigma Aldrich) were combined in a three-neck flask equipped with a KPG stirrer, an internal thermometer and a reflux condenser, and stirred for 5 hours at 70° C. The isopropanol was then distilled off at 80° C. and while applying an auxiliary vacuum (at 1 mbar). The mixture was rinsed out several times using water/NaCl/diethyl ether. Finally, the separated-off organic phase was dried over sodium sulphate and the diethyl ether was distilled off. This gave a clear, yellowish and highly viscous product. The ²⁹Si-NMR spectrum revealed a complete conversion of the vinyl groups.

### Application Examples of Hair Care

### 1.) Testing the Conditioning of Hair by Means of Sensory Tests:

For the applications-related assessment of the conditioning of hair, the compounds S1 according to the invention and the compound of the Comparative Example V1 as well as the commercially available product ABIL Quat 3272 (INCI: Quaternium-80, manufacturer Evonik Industries) were used in a simple cosmetic hair rinse formulation.

The applications-related properties upon use in hair rinses were tested in the following formulations:

| Formulation examples | 0a | 1a | V2a | V3a |
|---|---|---|---|---|
| TEGINACID ® C, Evonik Industries | 0.5% | 0.5% | 0.5% | 0.5% |
| (INCI: Ceteareth-25) | | | | |
| TEGO ® alkanol 16, Evonik Industries | 5% | 5% | 5% | 5% |
| (INCI: Cetyl Alcohol) | | | | |
| VARISOFT ® 300, 30% strength, Evonik | 3.3% | 3.3% | 3.3% | 3.3% |
| Industries (INCI: Cetrimonium chloride) | | | | |
| Water, demineralized | ad 100.0% | | | |
| Citric acid | ad pH 4.2 ± 0.3 | | | |
| S1 (according to the invention) | | 0.5% | | |
| Comparative Example V1 (not according | | | 0.5% | |
| to the invention) | | | | |
| ABIL Quat 3272 (not according to the | | | | 0.5% |
| invention) | | | | |

The hair was pretreated using a shampoo that contains no conditioners.

For the applications-related assessment, hair tresses that are used for sensory tests were predamaged in a standardized manner by means of a permanent wave treatment and a bleaching treatment. For this, customary hairstyling products were used. The test procedure, the base materials used, and the details of the assessment criteria have been described in DE 103 27 871.

Standardized treatment of predamaged hair tresses with conditioning samples:

The predamaged hair tresses, as described above, were treated as follows with the above-described conditioning rinse:

The hair tresses were wetted under running warm water. The excess water was gently squeezed out by hand, then the shampoo was applied and gently massaged into the hair (1 ml/hair tress (2 g)). After leaving on for 1 min, the hair was rinsed for 1 min. Immediately afterwards, the rinse was applied and gently massaged into the hair (1 ml/hair tress (2 g)). After leaving on for 1 min, the hair was rinsed for 1 min.

### Assessment Criteria:

The sensory assessments were made according to grades awarded on a scale from 1 to 5, with 1 being the worst assessment and 5 being the best assessment. The individual test criteria were each given their own assessment.

The test criteria are: wet combability, wet feel, dry combability, dry feel, appearance/shine.

The table below compares the results of the sensory assessment of the treatment, carried out as described above, of the hair tresses with the formulation 1a according to the invention, the comparison formulations V2a and V3a and the control formulation 0a (placebo without test substance).

| | Wet | | Dry | | |
|---|---|---|---|---|---|
| | combabil- | Wet | combabil- | Dry | |
| | ity | feel | ity | feel | Shine |
| Comparison formulation | 3.5 | 3 | 4 | 4 | 4 |
| (not according to the | | | | | |
| invention) V3a | | | | | |
| Formulation 1a | 4 | 3 | 4.5 | 4.5 | 4.5 |
| according to the | | | | | |
| invention | | | | | |
| Comparison formulation | 3.5 | 3 | 4 | 4 | 3 |
| (not according to the | | | | | |
| invention) V2a | | | | | |
| Control formulation 0a | 3 | 2.5 | 3.5 | 3.5 | 3 |

The formulation 1a according to the invention with the compound S1 according to the invention exhibited good cosmetic evaluations in the sensory assessment. Here, the already good properties of the comparison formulation V3a with the compound 1 were yet further increased by the formulation 1a according to the invention with the compound S1 according to the invention.

A significantly better assessment was also achieved in the case of shine as a result of using the formulation 1a according to the invention.

### 2.) Testing the Friction Values on Dry Hair by Means of a Friction Test:

The conditioning effect of the products on dry hair was investigated with help of a friction force measurement method (see also US 2009/0324530). For this purpose, an instrument from Instron (Instron 5942, Instron Deutschland GmbH, Pfungstadt, Germany) was used.

The instrument measures the force which is necessary to draw a slide over a real hair tress. The difference in force from the measurement before and the measurement after treatment with the conditioning reagent results in the reduction in friction value, and consequently an objectively ascertained value for the quality of the conditioner used. The slide, weighing 200 g and measuring 6×7 cm×0.5 cm, had a solid rubber surface. For each hair tress, this surface is replaced. Real hair tresses (7 cm in width, 18 cm free hair length, approx. 8.5 g) prewashed and predamaged by bleaching were used.

### Treatment of the Hair Tresses:

The products were used from a hair rinse as in the sensory test described above under 1.).

The hair rinse formulations were applied to the hair tress in a concentration of 0.5 g/2 g of hair, distributed evenly and massaged in for 1 min, left to act for 1 min and rinsed for 3 min using 38° C.-hot water. The hair tresses were left to dry overnight at 22° C. and 50% relative atmospheric humidity before being measured using the method described above on the Instron force measuring instrument.

The resulting reductions in friction value as a result of using the conditioners are shown in FIG. 1.

By reference to the measurement values, it is evident that a significant reduction in friction can be achieved with the formulation 1a with the compound S1 according to the invention compared to the formulation 0a without silicone component and also formulation V2a with the non-inventive compound V1.

It is also evident that a more marked reduction in friction can be achieved with the formulation 1a according to the invention with the compound S1 according to the invention than with the comparison formulation V2a with the Comparative Example V1 according to the prior art.

### Formulation Examples

### Textile Conditioning

### General Formulation:

5 to 50% by weight of the siloxanes according to the invention or of their solutions were placed in a beaker with propeller stirrer with stirring to give a mixture of 1.25 to 12.5% by weight of a lauryl alcohol ethoxylate with a degree of ethoxylation of 6-10 or a mixture with different degrees of ethoxylation, 0.05 to 0.5% by weight of concentrated acetic acid and 37.0 to 93.7% by weight of water.

### Formulation Example 1

### According to the Invention

20% by weight of the product from Synthesis Example S1 or S2 were placed in a beaker with propeller stirrer with stirring to give a mixture consisting of 8.0% by weight of a lauryl alcohol ethoxylate with a degree of ethoxylation of 6 and 2.0% by weight with a degree of ethoxylation of 10, 0.4% by weight of concentrated acetic acid and 69.6% by weight of water. This gave a white, low viscosity formulation.

Formulations were prepared analogously to the preparation of the general formulation. The comparison product OFX 8040A from Dow Corning is an amino-functional silicone fluid which can be used as soft handle agent for fibres and textiles.

### Prepared Formulations

| Formulation | | According to the |
|---|---|---|
| Example | Product used | invention |
| 1 | Synthesis Example S1 | yes |
| 2 | Synthesis Example S2 | yes |
| 3 | OFX 8040A | no |

### Application Examples

In order to examine the feel and the hydrophilicity of the products according to the invention, products consisting of native fibres were finished using the following process:

### Padding Process:

To examine the soft feel of the particular emulsions, knit cotton fabric (160 g/m²) and terry cotton fabric (400 g/m²) were padded with a liquor which comprised in each case 12.5 g/l of the corresponding emulsion, squeezed to a wet pick-up of approx. 100% and dried at 100° C. for three minutes.

To examine the hydrophilicity, woven cotton fabric (200 g/m²) was padded with a liquor which comprised in each case 150 g/l of the corresponding emulsion and squeezed to a wet pick-up of approx. 100% and dried at 130° C. for three to five minutes.

### Exhaust Process:

To examine the soft feel, knit cotton fabric (160 g/m²) and terry cotton fabric (400 g/m²) were immersed in a 0.025% strength (based on silicone active ingredient) liquor with a liquor ratio of 12:1 for 20 min with gentle mixing, lightly wrung out and dried in the oven at 100° C. To examine the hydrophilicity, woven cotton fabric (200 g/m²) was immersed into a 0.025% strength (based on silicone active ingredient) liquor with a liquor ratio of 120:1 for 20 min with gentle mixing and dried in the oven at 100° C.

### Test Methods:

### Feel Assessment:

To assess the feel of the fabric, an experienced team was gathered which evaluated the anonymized feel samples of the knit and terry fabrics finished with the emulsions using a hand panel test. In the case of the feel samples made of knit fabric, a non-overtly labelled untreated sample was additionally included.

### Washing Process:

The washing operations were carried out in a Miele Novotronic W 918 commercial washing machine with coloureds wash without prewash at 40° C. using wfk standard detergent IECA base and 3 kg of cotton ballast fabric. Lastly, the fabric treated in this way was dried for 12 hours at room temperature.

### Testing the Hydrophilicity:

To examine the hydrophilicity, the internal test method, based on DIN 53924, for measuring the height of rise of water was used. For this, the finished cotton test fabric is cut into strips each measuring 25 cm in length and 1.5 cm in width, marked with a water-soluble pen and secured in a tank perpendicular position, but without tension, to a holder. The holder is then placed into a water bath for 5 minutes in such a way that 2 cm of the strips dip into the water. After the holder has stood outside the water bath for 10 minutes, the height of rise is read off in cm and determined against the blank value (height of rise of the untreated cotton strips×cm=100%) and given as a % of the blank value.

Testing the thermal yellowing by means of measuring the degree of whiteness in accordance with Berger (Wb):

The instrument was operated in accordance with the manufacturer's instructions.

The fabric is placed onto a uniformly white substrate (4 ply cotton fabric). In each case, measurements are made of the unheated fabric and the heated, 5 minutes at 170° C., fabric. The nonfinished fabric serves here as “standard” or “blank value”. The average is formed from at least 3 points on the particular test fabric. The degree of whiteness is determined in accordance with Berger (Wb): the value is determined and indicated directly by the measuring instrument depending on the setting. In each case, the values for the individual fabrics (unheated and heated) and the difference between the two values is indicated. The difference is a measure of the yellowing as a result of thermal treatment. The lower the degree of whiteness in Wb, the greater the yellowing.

The test results as regards the soft feel, the hydrophilicity and the thermal yellowing properties are shown in the tables below.

Soft feel assessment on knit cotton fabric or terry cotton fabric following application by padding compared to a standard commercial aminosiloxane

| Formulation used | Knit cotton fabric | Terry cotton fabric |
|---|---|---|
| 1 (according to | ++ | ++ |
| the invention) | | |
| 2 (according to | +++ | +++ |
| the invention) | | |
| OFX 8040A | +++ | +++ |
| Untreated | − | − |

+++ excellent, ++ very good, + good, ∘ satisfactory, − poor

### Soft Feel Assessment Following Application by Padding and Exhaust Process

| | Padding | | Exhaust process | |
|---|---|---|---|---|
| Formulation | Knit cotton | Terry cotton | Knit cotton | Terry cotton |
| used | fabric | fabric | fabric | fabric |
| 1 (according to | ++ | ++ | +++ | ++ |
| the invention) | | | | |
| 2 (according to | +++ | +++ | ++ | ++ |
| the invention) | | | | |
| OFX 8040A | ++ | ++ | +++ | ++ |
| Untreated | − | − | − | − |

+++ excellent, ++ very good, + good, ∘ satisfactory, − poor

### Rewetting Behaviour on Woven Cotton Fabric in % of the Height of Rise of the Untreated Cotton Strip Following Application by Padding

| | Exhaust process | Padding |
|---|---|---|
| | [%] | [%] |
| Formulation 1 | 92 | 85 |
| (according to the invention) | | |
| Formulation 2 | 98 | 82 |
| (according to the invention) | | |
| OFX 8040A | 74 | 72 |
| Untreated | 100 | 100 |

### Thermal Yellowing:

| | Exhaust process | Padding |
|---|---|---|
| | delta Wb | delta Wb |
| Formulation 1 | 17 | 32 |
| (according to the invention) | | |
| Formulation 2 | 9 | 15 |
| (according to the invention) | | |
| OFX 8040A | 20 | 28 |
| Untreated | 7 | 7 |

### Summary of the Assessment:

A soft, very fleecy and silky feel of the textiles finished with the products according to the invention results. Moreover, the fabric finished in this way had a high elastic resilience and improved crease recovery properties.

In particular, it is evident that the softening effect of Formulation Example 2 following application by padding process is superior to that of Formulation Example 1. Added to this is a better wet pick-up of the fabric, which is reflected by the higher rewetting value. A further advantage is found in the case of thermal yellowing. The examples according to the invention, in particular Formulation Example 2, exhibit a clear advantage over the prior art since, besides a good soft feel, they exhibit advantages in the yellowing behaviour and in the hydrophilicity compared with standard commercial products.

### Further Formulation Examples

The formulation examples given in the tables below show exemplary representatives of a multitude of possible compositions according to the invention.

If the preparation of the formulation requires the separate preparation and/or mixing of formulation constituents beforehand, this is referred to as a multiphase preparation.

If a two-phase preparation is required, the two phases are labelled A and B in the given tables. In the case of three-phase processes, the three phases are called A, B and C. Unless stated otherwise, the data in the tables below are data in % by weight.

### Formulation Example 1

### Clear Shampoo

| | |
|---|---|
| TEXAPON ® NSO, Cognis, 28% strength | 32.00% |
| (INCI: Sodium Laureth Sulphate) | |
| Synthesis Example S1 | 2.50% |
| Perfume | 0.50% |
| Water | 55.50% |
| TEGO ® Betain F 50, Evonik Industries, 38% strength | 8.00% |
| (INCI: Cocamidopropyl Betaine) | |
| ANTIL ® 171 Evonik Industries | 1.00% |
| (INCI: PEG-18 Glyceryl Oleate/Cocoate) | |
| NaCl | 0.50% |
| Preservative | q.s. |

### Formulation Example 2

### Shampoo, PEG- & Sulphate Free

| | |
|---|---|
| REWOTERIC ® AM C, Evonik Industries, 32% strength, | 15.00% |
| (INCI: Sodium Cocoamphoacetate) | |
| Plantapon ACG 50, Cognis (INCI: Disodium Cocoyl | 3.80% |
| glutamate) | |
| Synthesis Example S2 | 2.00% |
| Perfume | 0.30% |
| Water | 64.30% |
| TEGO ® Betain F 50, Evonik Industries, 38% strength, | 10.00% |
| (INCI: Cocamidopropyl Betaine) | |
| VARISOFT ® PATC, Evonik Industries, | 2.30% |
| (INCI: Palmitamidopropyltrimonium chloride) | |
| ANTIL ® SPA 80, Evonik Industries, (INCI: | 2.00% |
| isostearamide MIPA, Glyceryl Laurate) | |
| Preservative | 0.30% |
| Citric acid, 30% strength | q.s. |

### Formulation Example 3

### Clear Conditioning Shampoo

| | |
|---|---|
| TEXAPON ® NSO, Cognis, 28% strength (INCI: | 32.00% |
| Sodium Laureth Sulphate) | |
| ANTIL ® 200, Evonik Industries (INCI: PEG-200 | 2.00% |
| Hydrogenated Glyceryl Palmate; PEG-7 Glyceryl | |
| Cocoate) | |
| Synthesis Example S2 | 2.00% |
| Perfume | 0.25% |
| Water | 55.25% |
| Polymer JR 400, Amerchol | 0.20% |
| (INCI: polyquaternium-10) | |
| TEGO ® Betain F 50, Evonik Industries, 38% strength | 8.00% |
| (INCI: Cocamidopropyl Betaine) | |
| NaCl | 0.30% |
| Preservative | q.s. |

### Formulation Example 4

### Clear conditioning shampoo

| | |
|---|---|
| TEXAPON ® NSO, Cognis, 28% strength (INCI: | 32.00% |
| Sodium Laureth Sulphate) | |
| ANTIL ® 200, Evonik Industries (INCI: PEG-200 | 2.00% |
| Hydrogenated Glyceryl Palmate; PEG-7 Glyceryl Cocoate) | |
| ABIL ® Quat 3272, Evonik Industries (INCI: | 0.75% |
| Quaternium-80) | |
| Synthesis Example S1 | 1.50% |
| Perfume | 0.25% |
| Water | 55.00% |
| Polymer JR 400, Amerchol | 0.20% |
| (INCI: polyquaternium-10) | |
| TEGO ® Betain F 50, Evonik Industries, 38% strength | 8.00% |
| (INCI: Cocamidopropyl Betaine) | |
| NaCl | 0.30% |
| Preservative | q.s. |

### Formulation Example 5

### Clear conditioning shampoo

| | |
|---|---|
| TEXAPON ® NSO, Cognis, 28% strength (INCI: | 32.00% |
| Sodium Laureth Sulphate) | |
| ANTIL ® 200, Evonik Industries (INCI: PEG-200 | 2.00% |
| hydrogenated Glyceryl Palmate; PEG-7 Glyceryl Cocoate) | |
| ABIL ® B 8832, Evonik Industries (INCI: | 0.50% |
| Bis-PEG/PPG-20/20 dimethicone) | |
| Synthesis Example S2 | 3.50% |
| Perfume | 0.25% |
| Water | 53.25% |
| Polymer JR 400, Amerchol | 0.20% |
| (INCI: polyquaternium-10) | |
| TEGO ® Betain F 50, Evonik Industries, 38% strength | 8.00% |
| (INCI: Cocamidopropyl Betaine) | |
| NaCl | 0.30% |
| Preservative | q.s. |

### Formulation Example 6

### Clear Conditioning Shampoo

| | |
|---|---|
| TEXAPON ® NSO, Cognis, 28% strength (INCI: | 32.00% |
| Sodium Laureth Sulphate) | |
| VARISOFT ® PATC, Evonik Industries | 1.50% |
| (INCI: Palmitamidopropyltrimonium chloride) | |
| REWODERM ® LI S 80, Evonik Industries | 2.00% |
| (INCI: PEG-200 hydrogenated Glyceryl Palmate; PEG-7 | |
| Glyceryl Cocoate) | |
| Synthesis Example S21 | 2.50% |
| Perfume | 0.25% |
| Water | 52.05% |
| TEGO ® Cosmo C 100, Evonik Industries, (INCI: Creatine) | 1.00% |
| Jaguar C-162, Rhodia (INCI: Hydroxypropyl Guar | 0.20% |
| Hydroxypropyltrimonium Chloride) | |
| TEGO ® Betain F 50, Evonik Industries, 38% strength | 8.00% |
| (INCI: Cocamidopropyl Betaine) | |
| NaCl | 0.50% |
| Preservative | q.s. |

### Formulation Example 7

### Clear Conditioning Shampoo

| | |
|---|---|
| TEXAPON ® NSO, Cognis, 28% strength | 32.00% |
| (INCI: Sodium Laureth Sulphate) | |
| REWODERM ® LI S 80, Evonik Industries | 2.00% |
| (INCI: PEG-200 Hydrogenated Glyceryl Palmate; PEG-7 | |
| Glyceryl Cocoate) | |
| Synthesis Example S2 | 2.50% |
| Perfume | 0.25% |
| Water | 53.55% |
| TEGO ® Cosmo C 100, Evonik Industries, (INCI: Creatine) | 1.00% |
| Jaguar C-162, Rhodia | 0.20% |
| (INCI: Hydroxypropyl Guar Hydroxypropyltrimonium | |
| Chloride) | |
| TEGO ® Betain F 50, Evonik Industries, 38% strength | 8.00% |
| (INCI: Cocamidopropyl Betaine) | |
| NaCl | 0.50% |
| Preservative | q.s. |

### Formulation Example 8

### Pearlized Shampoo

| | |
|---|---|
| TEXAPON ® NSO, Cognis, 28% strength (INCI: | 32.00% |
| Sodium Laureth Sulphate) | |
| Synthesis Example S1 | 5.50% |
| Perfume | 0.25% |
| Water | 49.25% |
| TEGO ® Betain F 50, Evonik Industries, 38% strength | 8.00% |
| (INCI: Cocamidopropyl Betaine) | |
| TEGO ® Pearl N 300 Evonik Industries (INCI: | 2.00% |
| Glycol Distearate; Laureth-4; Cocamidopropyl | |
| Betaine) | |
| ANTIL ® 171 Evonik Industries (INCI: PEG-18 Glyceryl | 2.50% |
| Oleate/Cocoate) | |
| NaCl | 0.50% |
| Preservative | q.s. |

### Formulation Example 9

### Shampoo, PEG- & Sulphate Free

| | | |
|---|---|---|
| A | REWOTERIC ® AMC, Evonik Industries, 32% strength, | 20.00% |
| | (INCI: Sodium Cocoamphoacetate) | |
| | REWOPOL ® SB F 12 P, Evonik Goldschmidt, 96% | 5.90% |
| | strength, (INCI: Disodium Lauryl Sulphosuccinate) | |
| | Synthesis Example S2 | 2.00% |
| | ANTIL ® SPA 80, Evonik Industries, (INCI: | 1.70% |
| | Isostearamide MIPA, Glyceryl Laurate) | |
| B | Water | 63.20% |
| | Citric acid, 30% strength | 3.60% |
| C | ANTIL ® HS 60, Evonik Industries, (INCI: | 3.00% |
| | Cocamidopropyl Betaine; Glyceryl Laurate) | |
| | Preservative | 0.60% |

### Formulation Example 10

### Rinse-Off Conditioner

| | |
|---|---|
| Water | 85.50% |
| VARISOFT ® BT 85, Evonik Industries | 3.00% |
| (INCI: Behentrimonium chloride) | |
| Synthesis Example S2 | 5.50% |
| TEGO ® alkanol 1618, Evonik Industries | 5.00% |
| (INCI: Cetearyl Alcohol) | |
| Preservative, Perfume | q.s. |

### Formulation Example 11

### Rinse-Off Conditioner

| | |
|---|---|
| Water | 90.20% |
| VARISOFT ® EQ 65, Evonik Industries | 2.00% |
| (INCI: Distearyl Dimonium Chloride, Cetearyl Alcohol) | |
| VARISOFT ® BT 85, Evonik Industries (INCI: | 1.00% |
| Behentrimonium Chloride) | |
| Synthesis Example S1 | 1.80% |
| TEGO ® alkanol 1618, Evonik Industries | 5.00% |
| (INCI: Cetearyl Alcohol) | |
| Preservative, Perfume | q.s. |

### Formulation Example 12

### Rinse-Off Conditioner

| | |
|---|---|
| Water | 87.20% |
| VARISOFT ® EQ 65, Evonik Industries | 2.00% |
| (INCI: Distearyl Dimonium Chloride, | |
| Cetearyl Alcohol) | |
| VARISOFT ® BT 85, Evonik Industries | 2.00% |
| (INCI: Behentrimonium Chloride) | |
| ABIL ® Quat 3272, Evonik Industries | 0.50% |
| (INCI: Quaternium-80) | |
| Synthesis Example S1 | 3.30% |
| TEGO ® alkanol 1618, Evonik Industries | 5.00% |
| (INCI: Cetearyl Alcohol) | |
| Preservative, perfume | q.s. |

### Formulation Example 13

### Rinse-Off Conditioner

| | |
|---|---|
| TEGINACID ® C, Evonik Industries (INCI: | 0.50% |
| Ceteareth-25) | |
| TEGO ® alkanol 16, Evonik Industries | 2.00% |
| (INCI: Cetyl Alcohol) | |
| TEGO ® amid S 18, Evonik Industries | 1.00% |
| (INCI: Stearamidopropyl Dimethylamine) | |
| Synthesis Example S2 | 5.50% |
| Propylene glycol | 2.00% |
| Citric acid monohydrate | 0.30% |
| Water | 88.70% |
| Preservative, perfume | q.s. |

### Formulation Example 14

### Rinse-Off Conditioner

| | |
|---|---|
| TEGINACID ® C, Evonik Industries (INCI: | 0.50% |
| Ceteareth-25) | |
| TEGO ® alkanol 16, Evonik Industries | 5.00% |
| (INCI: Cetyl Alcohol) | |
| TEGOSOFT ® DEC, Evonik Industries (INCI: | 1.00% |
| Diethylhexyl Carbonate) | |
| Synthesis Example S2 | 3.50% |
| Water | 87.20% |
| TEGO ® Cosmo C 100 Evonik Industries | 0.50% |
| (INCI: Creatine) | |
| Propylene glycol | 2.00% |
| Citric acid monohydrate | 0.30% |
| Preservative, perfume | q.s. |

### Formulation Example 15

### Leave-in Conditioner Spray

| | |
|---|---|
| Lactic Acid, 80% | 0.40% |
| Water | 92.30% |
| TEGO ® amid S 18, Evonik Industries | 1.20% |
| (INCI: Stearamidopropyl dimethylamine) | |
| TEGIN ® G 1100 Pellets, Evonik Industries | 0.60% |
| (INCI: Glycol Distearate) | |
| TEGO ® Care PS, Evonik Industries | 1.20% |
| (INCI: Methyl Glucose Sesquistearate) | |
| TEGOSOFT ® DEC, Evonik Industries | 0.30% |
| (INCI: Diethylhexyl Carbonate) | |
| Synthesis Example S1 | 4.00% |
| Preservative, perfume | q.s. |

### Formulation Example 16

### Leave-in Conditioner Spray

| | |
|---|---|
| TAGAT ® CH-40, Evonik Industries (INCI: PEG-40 | 2.00% |
| Hydrogenated Castor Oil) | |
| Ceramide VI, Evonik Industries (INCI: Ceramide 6 II) | 0.05% |
| Perfume | 0.20% |
| Water | 81.95% |
| Synthesis Example S2 | 9.50% |
| LACTIL ® Evonik Industries (INCI: Sodium Lactate; | 2.00% |
| Sodium PCA; Glycine; Fructose; Urea; Niacinamide; | |
| Inositol; Sodium benzoate; Lactic Acid) | |
| TEGO ® Betain F 50 Evonik Industries 38% | 2.30% |
| (INCI: Cocamidopropyl Betaine) | |
| Citric acid (10% in water) | 2.00% |

### Formulation Example 17

### Leave-in Conditioner Foam

| | |
|---|---|
| Synthesis Example S2 | 3.50% |
| TAGAT ® CH-40, Evonik Industries (INCI: PEG-40 | 0.50% |
| Hydrogenated Castor Oil) | |
| Perfume | 0.30% |
| TEGO ® Betain 810, Evonik Industries | 2.00% |
| (INCI: Capryl/Capramidopropyl Betaine) | |
| Water | 91.00% |
| TEGO ® Cosmo C 100, Evonik Industries | 0.50% |
| (INCI: Creatine) | |
| TEGOCEL ® HPM 50, Evonik Industries (INCI: | 0.30% |
| Hydroxypropyl Methylcellulose) | |
| VARISOFT ® 300, Evonik Industries | 1.30% |
| (INCI: Cetrimonium Chloride) | |
| LACTIL ® Evonik Industries (INCI: Sodium Lactate; | 0.50% |
| Sodium PCA; Glycine; Fructose; Urea; Niacinamide; | |
| Inositol; Sodium benzoate; Lactic Acid) | |
| Citric acid (30% in water) | 0.10% |
| Preservative | q.s. |

### Formulation Example 18

### Strong Hold Styling Gel

| | |
|---|---|
| TEGO ® Carbomer 141, Evonik Industries (INCI: Carbomer) | 1.20% |
| Water | 65.00% |
| NaOH, 25% | 2.70% |
| PVP/VA W-735, ISP (INCI: PVP/VA Copolymer) | 16.00% |
| Synthesis Example S1 | 2.50% |
| Alcohol Denat. | 10.00% |
| TAGAT ® O 2 V, Evonik Industries (INCI: PEG-20 Glyceryl Oleate) | 2.00% |
| Perfume | 0.30% |
| ABIL ® B 88183, Evonik Industries (INCI: PEG/PPG-20/6 | 0.30% |
| Dimethicone) | |
| Preservative | q.s. |

### Formulation Example 19

### Foaming Body Care Composition

| | |
|---|---|
| TEXAPON ® NSO, Cognis, 28% strength (INCI: | 14.30% |
| Sodium Laureth Sulphate) | |
| Perfume | 0.30% |
| Synthesis Example S2 | 1.50% |
| REWOTERIC ® AM C, Evonik Industries, 32% strength | 8.00% |
| (INCI: Sodium Cocoamphoacetate) | |
| Water | 73.90% |
| TEGOCEL ® HPM 50, Evonik Industries (INCI: | 0.50% |
| Hydroxypropyl Methylcellulose) | |
| LACTIL ®, Evonik Industries (INCI: Sodium Lactate; | 1.00% |
| Sodium PCA; Glycine; Fructose; Urea; Niacinamide; | |
| Inositol; Sodium benzoate; Lactic Acid) | |
| Citric acid monohydrate | 0.50% |

### Formulation Example 20

### Bodycare Composition

| | |
|---|---|
| TEXAPON ® NSO, Cognis, 28% strength (INCI: | 30.00% |
| Sodium Laureth Sulphate) | |
| TEGOSOFT ® PC 31, Evonik Industries (INCI: | 0.50% |
| polyglyceryl-3 Caprate) | |
| Synthesis Example S1 | 1.50% |
| Perfume | 0.30% |
| Water | 52.90% |
| TEGOCEL ® HPM 4000, Evonik Industries (INCI: | 0.30% |
| Hydroxypropyl Methylcellulose) | |
| REWOTERIC ® AM C, Evonik Industries, 32% strength | 10.00% |
| (INCI: Sodium Cocoamphoacetate) | |
| Citric acid monohydrate | 0.50% |
| REWODERM ® LI S 80, Evonik Industries | 2.00% |
| (INCI: PEG-200 Hydrogenated Glyceryl Palmate; PEG-7 | |
| Glyceryl Cocoate) | |
| TEGO ® Pearl N 300, Evonik Industries (INCI: | 2.00% |
| Glycol Distearate; Laureth-4; Cocamidopropyl | |
| Betaine) | |

### Formulation Example 21

### Foaming Body Care Composition

| | |
|---|---|
| TEXAPON ® NSO, Cognis, 28% strength (INCI: | 14.30% |
| Sodium Laureth Sulphate) | |
| Perfume | 0.30% |
| Synthesis Example S2 | 1.00% |
| REWOTERIC ® AM C, Evonik Industries, 32% strength | 8.00% |
| (INCI: Sodium Cocoamphoacetate) | |
| Water | 75.10% |
| Polyquaternium-7 | 0.30% |
| LACTIL ®, Evonik Industries (INCI: Sodium Lactate; | 0.50% |
| Sodium PCA; Glycine; Fructose; Urea; Niacinamide; | |
| Inositol; Sodium benzoate; Lactic Acid) | |
| Citric acid monohydrate | 0.50% |

### Formulation Example 22

### Mild Foam Bath

| | |
|---|---|
| TEXAPON ® NSO, Cognis, 28% strength (INCI: | 27.00% |
| Sodium Laureth Sulphate) | |
| REWOPOL ® SB FA 30, Evonik Industries, 40% strength | 12.00% |
| (INCI: Disodium Laureth Sulphosuccinate) | |
| TEGOSOFT ® LSE 65 K SOFT, Evonik Industries | 2.00% |
| (INCI: Sucrose Cocoate) | |
| Water | 38.00% |
| REWOTERIC ® AM C, Evonik Industries, 32% strength | 13.00% |
| (INCI: Sodium Cocoamphoacetate) | |
| Synthesis Example S1 | 1.50% |
| Citric acid (30% in water) | 3.00% |
| ANTIL ® 171 Evonik Industries (INCI: PEG-18 Glyceryl | 1.50% |
| Oleate/Cocoate) | |
| TEGO ® Pearl N 300 Evonik Industries (INCI: Glycol | 2.00% |
| Distearate; Laureth-4; Cocamidopropyl Betaine) | |

### Formulation Example 23

### Rinse-Off Conditioner

| | |
|---|---|
| Water | 88.20% |
| VARISOFT ® 300, Evonik Industries | 2.00% |
| (INCI: Cetrimonium Chloride) | |
| VARISOFT ® BT 85, Evonik Industries | 2.00% |
| (INCI: Behentrimonium Chloride) | |
| ABIL ® OSW 5, Evonik Industries | 1.00% |
| (INCI: Cyclopentasiloxane; Dimethiconol) | |
| Synthesis Example S2 | 1.80% |
| TEGO ® alkanol 1618, Evonik Industries | 5.00% |
| (INCI: Cetearyl Alcohol) | |
| Preservative, Perfume | q.s. |

### Formulation Example 24

### Rinse-Off Conditioner

| | |
|---|---|
| Water | 87.20% |
| VARISOFT ® EQ 65, Evonik Industries | 2.00% |
| (INCI: Distearyl Dimonium Chloride, Cetearyl Alcohol) | |
| VARISOFT ® BT 85, Evonik Industries | 2.00% |
| (INCI: Behentrimonium Chloride) | |
| ABIL ® Soft AF 100, Evonik Industries | 1.00% |
| (INCI: Methoxy PEG/PPG-7/3 Aminopropyl Dimethicone) | |
| Synthesis Example S1 | 2.80% |
| TEGO ® alkanol 1618, Evonik Industries | 5.00% |
| (INCI: Cetearyl Alcohol) | |
| Preservative, Perfume | q.s. |

### Formulation Example 25

### Rinse-Off Conditioner

| | |
|---|---|
| Water | 88.20% |
| VARISOFT ® BT 85, Evonik Industries | 3.00% |
| (INCI: Behentrimonium Chloride) | |
| SF 1708, Momentive (INCI: Amodimethicone) | 2.00% |
| Synthesis Example S2 | 1.80% |
| TEGO ® alkanol 1618, Evonik Industries | 5.00% |
| (INCI: Cetearyl Alcohol) | |
| Preservative, Perfume | q.s. |

### Formulation Example 26

### Moisturising Skin Cleanser

| | | |
|---|---|---|
| A | TEXAPON ® NSO, Cognis, 28% strength, (INCI: | 30.00 |
| | Sodium Laureth Sulphate) | |
| | Synthesis Example S1 | 1.70 |
| | Perfume | 0.30 |
| B | Water | 54.60 |
| | TEGOCEL ® fluid HPM 4000, Evonik Industries, | 1.20 |
| | (INCI: Hydroxypropyl Methylcellulose) | |
| | TEGO ® Betain C 60, Evonik Industries, 46% strength, | 8.10 |
| | (INCI: Cocamidopropyl Betaine) | |
| | TEGOSOFT ® APM, Evonik Industries, (INCI: | 1.00 |
| | PPG-3 Myristyl Ether) | |
| | Cutina TS, Cognis (INCI: PEG- 3 Distearate) | 1.00 |
| | REWODERM ® LI S 80, Evonik Industries, | 1.50 |
| | (INCI: PEG-200 Hydrogenated Glyceryl Palmate; | |
| | PEG-7 Glyceryl Cocoate) | |
| | Preservative | 0.60 |
| | Citric acid, 30% strength | q.s. |

### Formulation Example 27

### Shower Gel

| | |
|---|---|
| TEXAPON ® NSO, Cognis, 28% strength (INCI: | 15.00 |
| Sodium Laureth Sulphate) | |
| Synthesis Example S2 | 1.50 |
| Perfume | 0.30 |
| PGFAC-S, Cognis (INCI: Sodium cocoyl hydrolyzed | 1.50 |
| wheat protein glutamate) | |
| REWOPOL SB CS 50 B, Evonik Industries, 40% strength, | 7.50 |
| (INCI: Disodium PEG-5 Laurylcitrate | |
| Sulphosuccinate; Sodium Laureth Sulphate) | |
| Water | 58.10 |
| TEGO ® Betain F 50, Evonik Industries, 38% strength, | 9.00 |
| (INCI: Cocamidopropyl Betaine) | |
| TEGO ® Betain 810, Evonik Industries, 38% | 4.00 |
| strength, (INCI: Capryl/Capramidopropyl Betaine) | |
| Polyquaternium- 7, Nalco, (INCI: Merquat 550) | 0.50 |
| ANTIL ® 200, Evonik Industries, (INCI: PEG-200 | 2.30 |
| Hydrogenated Glyceryl Palmate; PEG-7 Glyceryl Cocoate) | |
| Preservative | 0.30 |

### Formulation Example 28

### Body Cleansing Composition

| | | |
|---|---|---|
| A | TEXAPON ® NSO Cognis 28% strength, (INCI: | 30.00 |
| | Sodium Laureth Sulphate) | |
| | Synthesis Example S1 | 1.50 |
| | ABIL ® B 8832, Evonik Industries, (INCI: | 0.30 |
| | Bis-PEG/PPG-20/20 Dimethicone) | |
| | Perfume | 0.30 |
| B | Water | 51.00 |
| | TEGOCEL ® fluid HPM 4000, Evonik Industries, | 1.20 |
| | (INCI: Hydroxypropyl Methylcellulose) | |
| | Citric acid monohydrate | 0.50 |
| | REWOTERIC ® AM C, Evonik Industries, 32% strength, | 10.00 |
| | (INCI: Sodium Cocoamphoacetate) | |
| | Cutina TS, Cognis (INCI: PEG- 3 Distearate) | 2.00 |
| | REWODERM ® LI S 80, Evonik Industries, | 2.60 |
| | (INCI: PEG-200 Hydrogenated Glyceryl Palmate; | |
| | PEG-7 Glyceryl Cocoate) | |
| | Preservative | 0.60 |
| | Citric acid, 30% strength | q.s. |

### Formulation Example 29

### Body Cleansing Foam

| | |
|---|---|
| TEXAPON ® NSO, Cognis, 28% strength (INCI: | 14 |
| Sodium Laureth Sulphate) | |
| Perfume | 0.3 |
| Synthesis Example S2 | 0.7 |
| REWOTERIC ® AM C, Evonik Industries, 32% strength | 8 |
| (INCI: Sodium Cocoamphoacetate) | |
| Water | 74.8 |
| TEGOCEL ® HPM 50, Evonik Industries (INCI: | 0.5 |
| Hydroxypropyl Methylcellulose) | |
| LACTIL ®, Evonik Industries (INCI: Sodium Lactate; | 1 |
| Sodium PCA; Glycine; Fructose; Urea; Niacinamide; | |
| Inositol; Sodium benzoate; Lactic Acid) | |
| Panthenol, BASF, (INCI: D- Panthenol USP) | 0.2 |
| Citric acid monohydrate | 0.5 |

### Formulation Example 30

### Turbid Conditioning Shampoo

| | |
|---|---|
| TEXAPON ® NSO, Cognis, 28% strength (INCI: | 32.00 |
| Sodium Laureth Sulphate) | |
| ANTIL ® 200, Evonik Industries (INCI: PEG-200 | 2.00 |
| Hydrogenated Glyceryl Palmate; PEG-7 Glyceryl Cocoate) | |
| Synthesis Example S1 | 1.00 |
| Perfume | 0.25 |
| Water | 53.25 |
| Polymer JR 400, Amerchol (INCI: Polyquaternium-10) | 0.20 |
| TEGO ® Betain F 50, Evonik Industries, 38% strength | 8.00 |
| (INCI: Cocamidopropyl Betaine) | |
| DC1503 Fluid, Dow Corning, (INCI: dimethicone, | 1.00 |
| dimethiconol) | |
| TEGO ® Pearl N 300 Evonik Industries (INCI: | 2.00 |
| Glycol Distearate; Laureth-4; Cocamidopropyl Betaine) | |
| NaCl | 0.30 |
| Preservative | q.s. |

### Formulation Example 31

### Mild Hair & Body Wash, PEG- and Sulphate-Free

| | |
|---|---|
| Plantacare ® 1200 UP, Cognis, 50% strength, (INCI: | 11.40% |
| Lauryl Glucoside) | |
| Plantacare ® 818 UP, Cognis, 51% strength, (INCI: | 5.60% |
| Coco Glucoside) | |
| Water | 61.60% |
| ANTIL ® SOFT SC, Evonik Industries, (INCI: Sorbitan | 0.90% |
| Sesquicaprylate) | |
| Synthesis Example S2 | 1.00% |
| TEGOSOFT ® LSE 65 K SOFT, Evonik Industries, | 1.50% |
| (INCI: Sucrose Cocoate) | |
| TEGO ® Betain F 50, Evonik Industries, 38% strength, | 18.00% |
| (INCI: Cocamidopropyl Betaine) | |
| Perfume, preservative | q.s. |
| Citric acid, 30% | q.s. |

### Formulation Example 32

### Sprayable Hair Milk, PEG-Free

| | | |
|---|---|---|
| A | Water | 95.30% |
| | Lactic Acid, 80% strength | 0.40 |
| B | TEGO ® AMID S 18, Evonik Industries, (INCI: | 1.20% |
| | Stearamidopropyl Dimethylamine) | |
| | TEGIN ® G 1100 Pellets, Evonik Industries, | 0.60% |
| | (INCI: Glycol Distearate) | |
| | TEGO ® Care PS, Evonik Industries, (INCI: | 1.20% |
| | Methyl Glucose Sesquistearate) | |
| | TEGOSOFT ® DEC, Evonik Industries, (INCI: | 0.30% |
| | Diethylhexyl Carbonate) | |
| | Synthesis Example S2 | 1.00% |
| | Perfume, preservative | q.s. |

1. A siloxane according to general formula I
Mₐ₁M^{A}ₐ₂M^{B}ₐ₃M^{C}ₐ₄D_{b1}D^{A}_{b2}D^{B}_{b3}D^{C}_{b4}T_{c1}T^{A}_{c2}T^{B}_{c3}T^{C}_{c4}Q_{d1} (general formula I)
where
M=[R¹₃SiO_{1/2}]
M^{A}=[R²R¹₂SiO_{1/2}]
M^{B}=[R³R¹₂SiO_{1/2}]
M^{C}=[R⁴R¹₂SiO_{1/2}]
D=[R¹₂SiO_{2/2}]
D^{A}=[R²₁R¹₁SiO_{2/2}]
D^{B}=[R³₁R¹₁SiO_{2/2}]
D^{C}=[R⁴₁R¹₁SiO_{2/2}]
T=[R¹SiO_{3/2}]
T^{A}=[R²SiO_{3/2}]
T^{B}=[R³SiO_{3/2}]
T^{C}=[R⁴SiO_{3/2}]
Q=[SiO_{4/2}],
where
R¹ independently of one another, are identical or different linear or branched, saturated or unsaturated hydrocarbon radicals having 1 to 30 carbon atoms or aromatic hydrocarbon radicals having 6 to 30 carbon atoms,
R² independently of one another, are identical or different radicals of general formula II 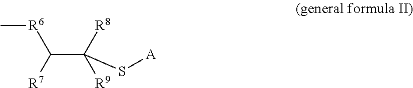
where A=an organic radical having at least one primary amino group and at least one of a carboxy group and an ester group,
R⁶ is a direct bond, a divalent organic radical bonded to the siloxane, esters, or amides,
R⁷ is hydrogen, substituted or unsubstituted C₁-C₃₀-alkyl, substituted or unsubstituted C₆-C₃₀-aryl, substituted or unsubstituted C₆-C₃₀-heteroaryl, substituted or unsubstituted C₁-C₃₀-alkyloxy, substituted or unsubstituted cyclic C₃-C₃₀-alkyl, or substituted or unsubstituted C₁-C₃₀-alkenyl,
R⁸ is hydrogen, substituted or unsubstituted C₁-C₃₀-alkyl, substituted or unsubstituted C₆-C₃₀-aryl, substituted or unsubstituted C₆-C₃₀-heteroaryl, substituted or unsubstituted C₁-C₃₀-alkyloxy, substituted or unsubstituted cyclic C₃-C₃₀-alkyl, or substituted or unsubstituted C₁-C₃₀-alkenyl,
R⁹ is hydrogen, substituted or unsubstituted C₁-C₃₀-alkyl, substituted or unsubstituted C₆-C₃₀-aryl, substituted or unsubstituted C₆-C₃₀-heteroaryl, substituted or unsubstituted C₁-C₃₀-alkyloxy, substituted or unsubstituted cyclic C₃-C₃₀-alkyl, or substituted or unsubstituted C₁-C₃₀-alkenyl,
R³ independently of one another, are identical or different linear or branched, saturated or olefinically unsaturated hydrocarbon radicals having 8 to 30 carbon atoms,
R⁴ independently of one another, are identical or different linear or branched hydrocarbon radicals which carry nitrogen- and/or oxygen-functional groups,
a1=0-200,
a2=0-30,
a3=0-30,
a4=0-30,
b1=10 to 5000,
b2=0 to 100,
b3=0 to 100,
b4=0 to 100,
c1=0 to 30,
c2=0 to 30,
c3=0 to 30,
c4=0 to 30,
d1=0 to 30,
with the proviso that at least one of the indices a2, b2 or c2 is ≠0 and that at least one of the indices a1 to a4 is ≠0.

2. The siloxane according to claim 1, wherein
a1=0, a2=2, a3=0, a4=0, b1=5-350, b2=0, b3=0, b4=0, c1=0, c2=0, c3=0, c4=0 and d1=0,
a1=3-12, a2=0, a3=0, a4=0, b1=15-350, b2=0, b3=0, b4=0, c1=0, c2=1-10, c3=0, c4=0 and d1=0,
a1=2, a2=0, a3=0, a4=0, b1=10-350, b2=1-30, b3=0, b4=0, c1=0, c2=0, c3=0, c4=0 and d1=0,
a1=0, a2=2, a3=0, a4=0, b1=10-350, b2=1-30, b3=0, b4=0, c1=0, c2=0, c3=0, c4=0 and d1=0,
a1=0, a2=3-12, a3=0, a4=0, b1=15-350, b2=0, b3=0, b4=0, c1=1-10, c2=0, c3=0, c4=0 and d1=0,
a1=0, a2=4-22, a3=0, a4=0, b1=20-350, b2=0, b3=0, b4=0, c1=0, c2=0, c3=0, c4=0 and d1=1-10,
a1=2-11, a2=2-11, a3=0, a4=0, b1=20-350, b2=0, b3=0, b4=0, c1=0, c2=0, c3=0, c4=0 and d1=1-10,
a1=2-11, a2=2-11, a3=0, a4=0, b1=20-350, b2=1-10, b3=0, b4=0, c1=0, c2=0, c3=0, c4=0 and d1=1-10,
a1=0, a2=3-12, a3=0, a4=0, b1=15-350, b2=1-10, b3=0, b4=0, c1=1-10, c2=0, c3=0, c4=0 and d1=0,
a1=3-12, a2=0, a3=0, a4=0, b1=15-350, b2=1-10, b3=0, b4=0, c1=0, c2=1-10, c3=0, c4=0 and d1=0, or
a1=0, a2=5=17, a3=0, a4=0, b1=30-50, b2=0, b3=0, b4=0, c1=1-5, c2=0, c3=0, c4=0 and d1=1-5.

3. The siloxane according to claim 1, wherein
R⁶ independently of one another, are identical or different radicals of general formula III 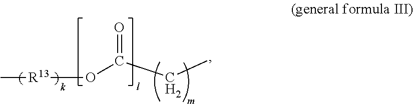
where
k=0 or 1,
l=0 or 1,
m=0-30,
R¹³ is a hydrocarbon radical optionally substituted with —O—, —NH— or hydroxy groups,
R⁷ is hydrogen or substituted or unsubstituted C₁-C₂₀-alkyl,
R⁸ is hydrogen or substituted or unsubstituted C₁-C₂₀-alkyl,
R⁹ is hydrogen or substituted or unsubstituted C₁-C₂₀-alkyl.

4. The siloxane according to claim 1, wherein R² is selected from IIa to IIk

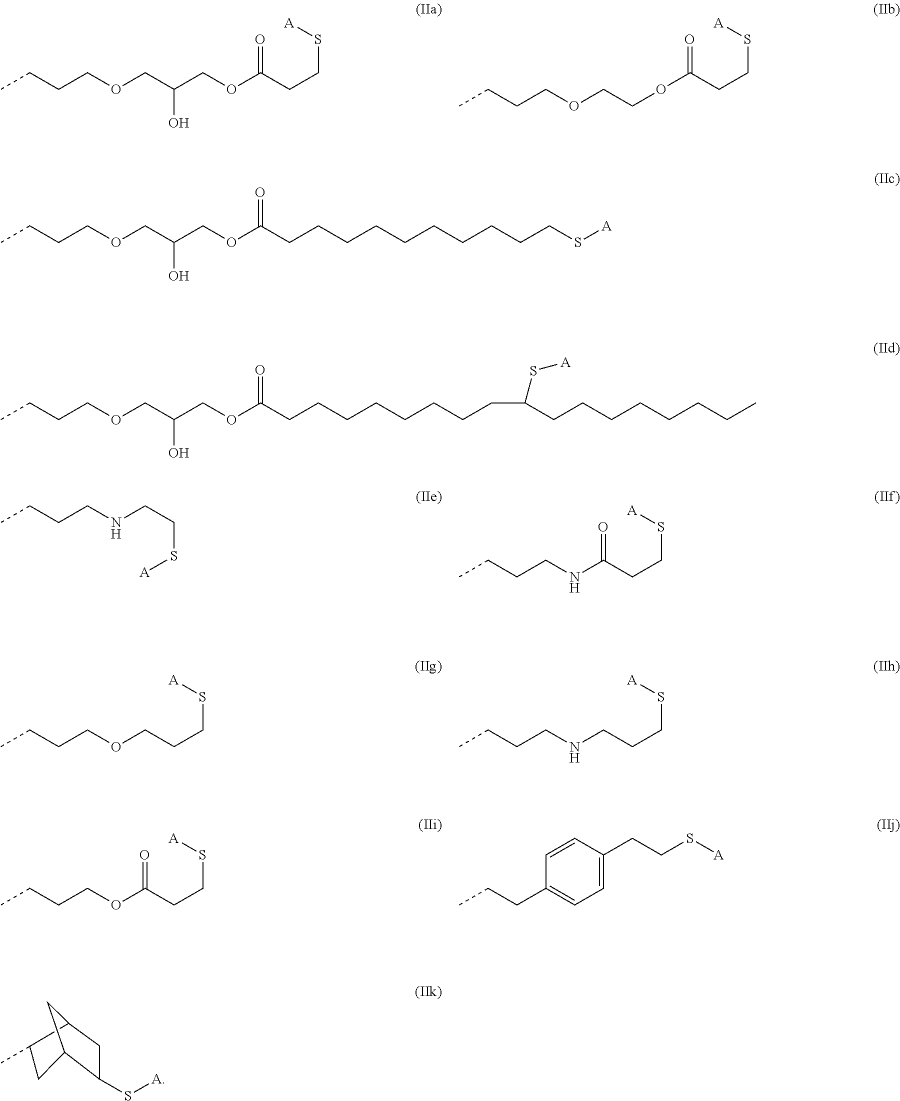

5. The siloxane according to claim 1, wherein the sulphur atom in the group —S-A of general formula II is derived from a thiol group of cysteine.

6. The siloxane according to claim 1, wherein the group —S-A of general formula II is derived from an oligo- or polypeptide containing at least one cysteine radical.

7. The siloxane according to claim 1, wherein the radical A has no N-acylation.

8. The siloxane according to claim 1, wherein R⁴ is selected from radicals of general formulae IIIa to IIIh 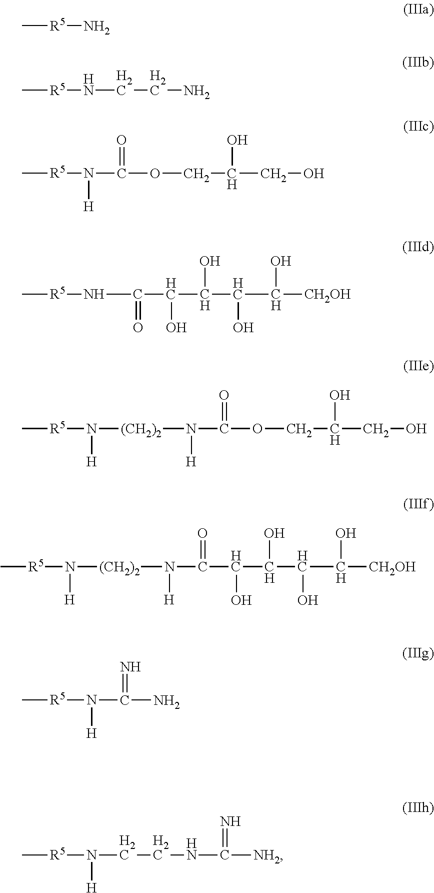
where
R⁵ independently of one another, are identical or different linear or branched, saturated or unsaturated, divalent hydrocarbon radicals.

9. A process for the preparation of siloxanes containing amino groups, said process comprising:
reacting a mixture comprising component a) at least one siloxane with at least one olefinically unsaturated radical, and component b) at least one organic compound containing at least one thiol group, at least one primary amino group and at least one selected from a carboxy group and an ester group.

10. The process according to claim 9, wherein said component b) is selected from oligo- or polypeptides containing at least one cysteine and which are glycosylated or esterified on the C-terminus with an alcohol radical R¹⁰ wherein R¹⁰ is hydrogen, a fatty alcohol radical, or an alkyl radical.

11. The process according to claim 9, wherein said component b) has no N-acylation.

12. A siloxane obtained by a process according to claim 9.

13. (canceled)

14. A formulation for use in domestic and industrial sectors, said formulation comprising at least one siloxane according to claim 1.

15. (canceled)
